(19) United States
(12) Patent Application Publication
(10) Pub. No.: US 2008/0186163 A1
(43) Pub. Date: Aug. 7, 2008

(54) Self contained container tracking device

(76) Inventor: Ian Michael Mills, Aurora, CO (US)

Correspondence Address: Ian Mills, 12444 E Amherst Circle, Aurora, CO, 80014, US

(21) Appl. No.: 11/880,613

(22) Filed: Jul. 24, 2007

Related U.S. Application Data
(60) Provisional application No. 60/836,561, filed on Aug. 10, 2006.

(51) Int. Cl. H04Q 7/00

(52) U.S. Cl. 340/539.13

(57) ABSTRACT

A system for tracking the locations of a freight container using a self contained and portable container tracking device is described.

The container tracking device includes a GPS receiver, an attachment mechanism to easily secure the tracking device to the interior of a container door, an intrusion detection system and an alarm. The user can access the position and status information through a web site Internet access to a centralized database, SMS interrogation or SMS message updates.
The user can load map information, trip alarm conditions, update method, as well as authentication information on a flash drive and insert it in the tracking device.
In the event an alarm condition is broken, an alarm is triggered and an alarm message is sent to the user.
The tracking device is located inside the container whereas its antennas are located on the outside. This prevents damage, tampering and theft of the tracking device.

The present patent application claims priority to Provisional U.S. Patent Application Ser. No. 60/836,561 filed on Aug. 10, 2006.

### FIELD OF THE INVENTION

This invention relates to a system and method for remotely monitoring freight containers using an easily installed and monitored global positioning satellite tracking system.

### BACKGROUND OF THE INVENTION

The present invention relates to monitoring trailers and containers while in transit, and in particular to a portable, reusable electronic device that is easily installed in the container and that provides for locating and tracking of cargo containers using a cell phone or a computer.

Two types of security devices are typically used in the market today that provide for limited protection of cargo containers. These include physical locks and electronic seals.

A physical lock is a straightforward device. One closes both of the doors that are typically on the rear of a shipping container, and places locks on each door handle. Variations on this approach include bars, cables and housings. Unfortunately, these approaches have problems including: key distribution to recipients and/or loss of the key in transit to open the lock; custom requirements to inspect the locked container's contents upon arrival at a port; and the possibility that forced entry will occur through means other than the door, such as by removal of door hinges, access pins, prying of side panels and the like.

A second approach is to attach an electronic seal that records a variety of activities. The seal can typically be interrogated by a data collection device. The collection device is typically a hand held device that can, for example, document an action such as a door being opened. These systems typically lack the ability to transmit the information independently of ground personnel or ground systems, and thus cannot be used to monitor cargo in-transit.

While both electronic seals and the asset management systems may deter and/or document entry into a container, they do not provide an opportunity to react quickly. A more proactive stance is required involving security breaches, not just from the security threat standpoint but also from an inventory management perspective as well.

Several tracking techniques are used to track the location of a container. LoJack.™. system in the United States, permanently attaches a wireless transceiver to a mobile object such as a truck or car. The transceiver range and the type of data it provides are highly dependent upon the application and upon the vehicle remaining in range of terrestrial radio networks.

U.S. Pat. No. 6,483,434 by Umiker discusses a container tracking system that uses transponders to monitor the movements of containers in a yard. A plurality of read/write units is located on a track or a trajectory of the containers, and records the id of the container.

Prior art devices and systems exist for tracking the location of mobile units, including vehicles and/or persons. These systems are capable of monitoring present position, progress along a given route, determining that an emergency has occurred, and other functions. They invariably use electronic position sensors, Global Positioning System (GPS) receivers, Long Range Navigation (LORAN), or similar devices to obtain a position and then report that position to a central location via a radio modem.

U.S. Pat. No. 6,266,008 by Huston et al. discloses a system and method for determining freight container locations within a storage yard. The system consists of attaching GPS receivers and transceivers to the container units. The container locations are collected in a database that can be searched by users.

U.S. Pat. No. 6,577,921 by Carson discussed a container tracking system within a storage yard that uses a GPS tracking system onboard container handling equipment and monitors changes of containers locations within a yard.

A GPS navigation receiver is coupled with a cell phone, and both are attached to a shipping container in U.S. Pat. No. 5,835,377, issued Nov. 10, 1998, to Ronald Bush. Such tracking module is described as being built into each shipping container.

U.S. Pat. No. 6,975,224 by Galley et al. presents a reusable self-contained electronic device providing in-transit cargo visibility. It discloses a system containing a GPS and cellular modem that is easily installed and removed by the user and that allows a user to monitor a container through the Internet. The system attaches to the vertical locking bars outside a container and is subject to tampering, damage and theft.

Thus there is a need for a more convenient, effective, tamper proof method and apparatus for monitoring container locations and providing status information.

### SUMMARY OF INVENTION

A unitary apparatus comprising: a housing containing circuitry for determining status and location data associated with an attached shipping container and for communicating said data to a remote server;

an activation system, for electrically activating or deactivating the circuitry;

a latch for mechanically attaching and detaching said housing from the door edge of said shipping container;

said latch extends from the housing and is shaped to accommodate positioning of the housing adjacent to the container door, on the inside of the container,

said latch extends adjacent to the container door to the outside of the container and comprises a restraint mechanism and antennas for GPS and cellular receivers.

A method for tracking a container using a unitary tamper proof apparatus comprising: attaching a housing containing a GPS receiver, a cellular receiver and circuitry for determining the status of said container adjacent to the container door to the inside of the container, attaching a latch extending from said housing adjacent to the container door, to the exterior of the container, fastening said latch to said container door.

A method for tracking a container using a unitary temper proof apparatus comprising: attaching a housing containing a GPS receiver, a cellular receiver and circuitry for determining the status of said container adjacent to the container door to the inside of the container, attaching a latch extending from the housing adjacent to the container door,

to the exterior of the container,

fastening said latch to said container door,

said apparatus reads configuration information from a flash drive,

periodically,

said GPS receiver determines position information,

said cellular receiver sends said position information through GPRS,

whereby on occurrence of an exception event, said apparatus goes to alarm mode.

### BRIEF DESCRIPTION OF THE DRAWINGS

The present invention with be more clearly understood after reference to the following detailed specifications read in conjunction with the drawings wherein:

FIG. 1 is a diagram illustrating a container equipped with a container tracking device

FIG. 2 is a schematic of a container tracking system

FIG. 3 is a schematic illustrating a container tracking system installed on a container door

FIG. 4 is a block diagram of a container tracking system

FIG. 5 is an alternative container tracking system

FIG. 6 is an alternative container tracking system

Similar reference numerals are used in different figures to denote similar components.

### DETAILED DESCRIPTION OF THE PREFERRED EMBODIMENTS

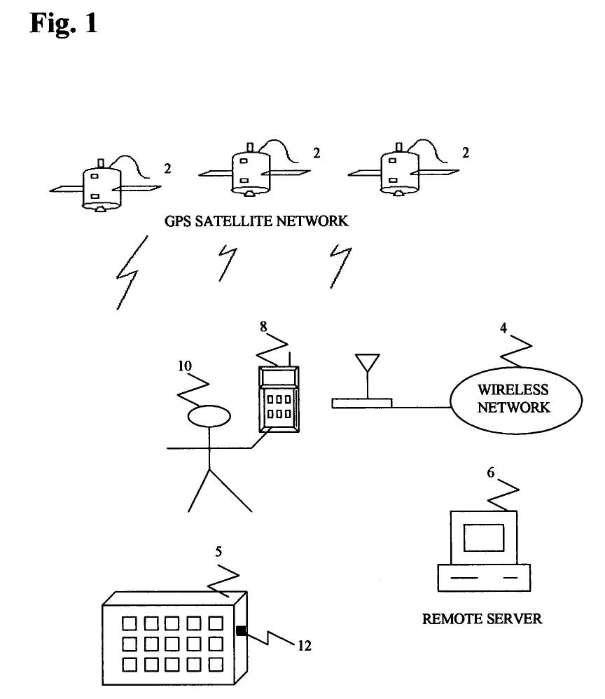

Referring to FIG. 1, a container 5 equipped with a container tracking device 12 collaborates with GPS constellation 2 to determine position information.

Container tracking device 12 collaborates with wireless network 4 to receive commands and to send position information to user 10 either through remote server 6 or mobile unit 8.

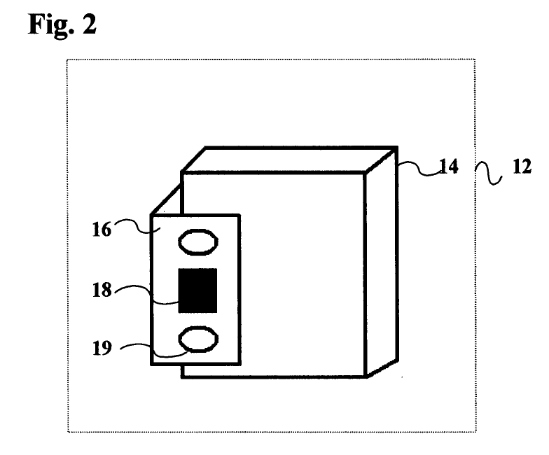

Referring to FIG. 2, container tracking device 12 comprises restraint unit 16 used to attach the container tracking device housing 14 to a container door. Restraint unit 16 comprises an antenna system for the GPS and wireless transceiver systems as well as mechanism 19 for fastening the bracket to the container door.

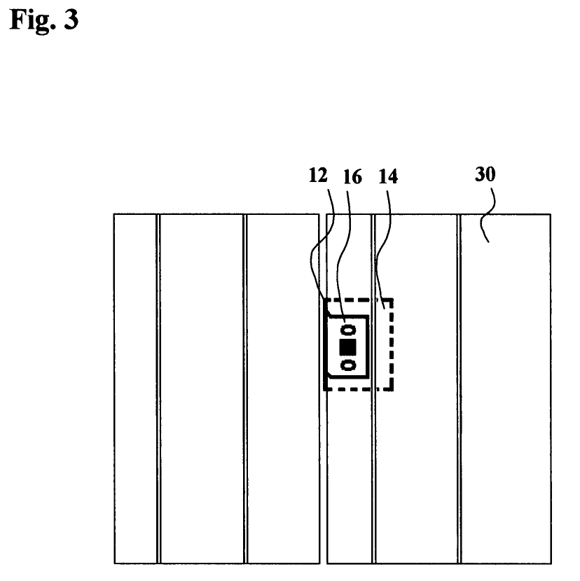

FIG. 3 is a schematic illustrating a container tracking device 12 installed on a container door 30, whereby housing 14 is positioned adjacent to the container door, on the inside of the container, and restraint unit 16 with antennas for GPS and cellular receivers is positioned to the outside of the container.

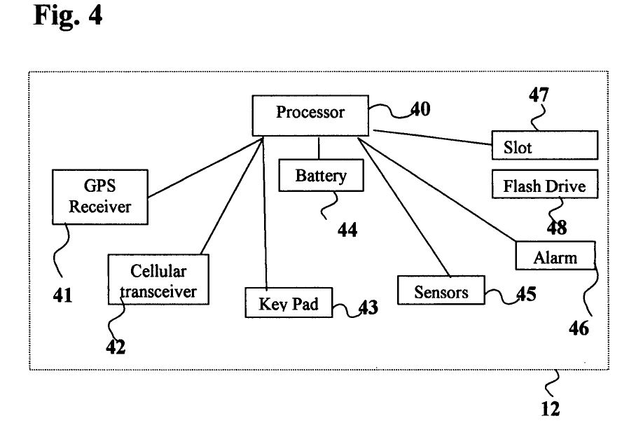

Referring now to FIG. 4, in one embodiment, container tracking device housing 14 comprises a processor 40 interconnected with GPS receiver 41, cellular transceiver 42, sensors 45, alarm 46, battery 44 and slot 47 for removable flash drive 48. Alternatively, the container tracking device may comprise a key pad 43.

GPS receiver 41 may be a GSP, GLONASS, LORAN, GNSS, or any other commercially available service, or combination of services, which provide global position information.

Cellular transceiver 42 may be any cellular receiver capable of SMS or GPRS.

SMS is Short Message Service. It is available on wireless networks allowing text messages of up to 160 characters to be sent and received via the network operator's message center to a mobile phone/portable terminal, or from the Internet, using a so-called “SMS gateway” website. If the mobile phone/portable terminal is powered off or out of range, messages are stored in the network and are delivered at the next opportunity.

GPRS is General Packet Radio Service, a data transmission technique that transmits and receives data in packets between portable terminals/mobile phones or between a portable terminal/mobile phone and a second terminal.

Sensors 45 may be any sensors for detecting intrusion, door opening, motion, temperature, sound, beam crossing, light, acceleration, or any other conditions. Sensors 45 may be locks, actuators, motors, contact switches/sensors, reed switches, buttons, infrared/ultrasound sensors, heat sensors, light sensors, acceleration sensors, or any other sensors capable of detecting intrusion.

Alarm 30 may be a loud alarm with more than 85 decibels.

Battery 44 provides power to some of the components of container tracking device 12. It will be understood that battery 44 may be nickel-cadmium, lithium, alkaline or nickel-hydride battery or any other portable source of electric power.

Flash drive 4 may be a USB flash or any portable storage device or memory device. Flash drive 4 holds user configuration information such as:

operation modes,

alarm conditions,

location names database,

alert method,

sensor thresholds,

alarm thresholds,

authorized passwords,

authorized load/unload zones,

authorized checkpoints, and any other information.

Configuration information is loaded onboard flash drive 4 through a standard computer system.

A software application may be used to collect information from the user and to organize data on flash drive 4 in a way that processor 40 may interpret it.

A software application may also be used to organize and load map information on flash drive 40.

In an alternative embodiment, key pad 43 is used to authenticate the user against authentication reference data obtained from flash drive 4 or obtained through SMS messaging.

As described hereafter, processor 40 reads configuration information off a flash drive 48 inserted in slot 47. Slot for flash drive 47 can be a USB slot or any connector compatible with removable flash drive 48.

Processor 40 may activate tracking device 12 on detection of insertion of Flash drive 48 into slot 47 aboard the tracking device 12.

Processor 40 obtains location information from GPS receiver 41 and may correlate it to location names from flash drive 48.

Processor 40 may receive trigger events through cellular transceiver 42. It sends location information through cellular transceiver 42.

In an alternative embodiment, on receipt on an SMS message, processor 40 replies with a new SMS message containing location and/or status information.

In an alternative embodiment, on receipt on an SMS message containing data, processor 40 authenticates the message data then replies with a new SMS message containing location and/or status information.

In an alternative embodiment, on receipt on an SMS message containing instructions, processor 40 executes said instructions. Said instructions may indicate reporting position to a specific phone number such as police station or to a number of phone numbers.

Processor 40 may periodically send position and/or status information to a destination number.

Processor 40 may transfer data through data packets, data stream, voice information, file transfer or any other data transfer method.

Processor 40 monitors sensors 45 to detect exception events such as intrusion, deviation from a path, abnormal driving, accident, abnormal conditions such as high temperature, or any condition that is a cause for concern. Processor 40 may compare sensor 45 data against user thresholds established in flash drive 48. On deviation from user thresholds, an alarm mode is entered.

In alarm mode, onboard alarm 30 may be activated. SMS messages may be sent. Also, phone numbers may be called and messages played.

When container tracking device 12 is not in operation it remains in a dormant state (“sleep-mode”) to conserve the energy of battery 44.

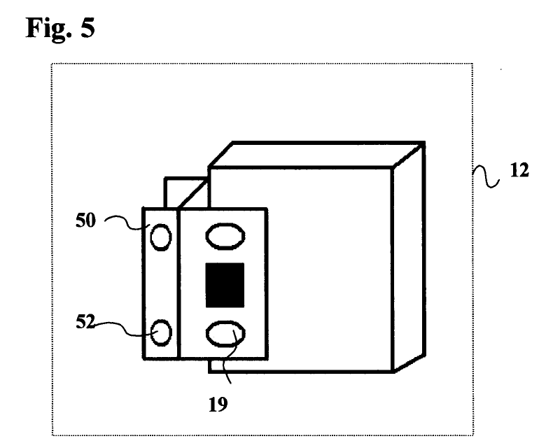

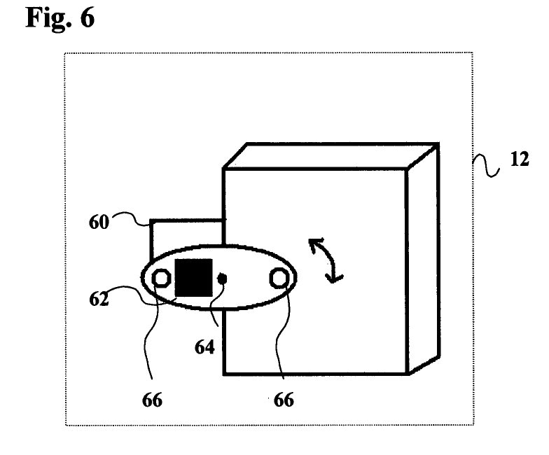

FIG. 5 is an alternative container tracking device whereby restraint unit 50 extends outwards and to the side of the housing and allows inserting tracking device 12 between both container doors when closing the container doors. This system allows fastening the tracking device to both container doors through mechanism 52.

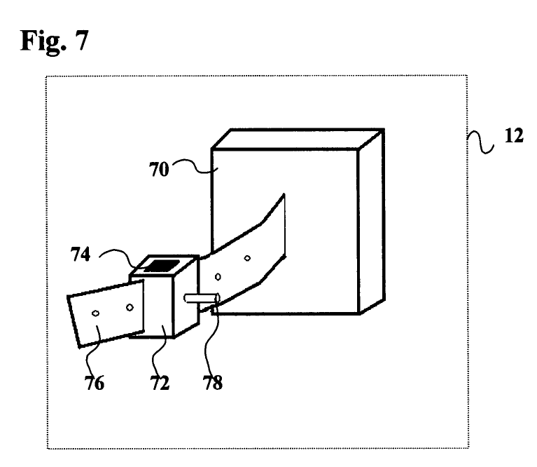

FIG. 6 is an alternative container tracking system whereby restraint unit 62 rotates around an axis 64 and allows fastening the tracking device to both container doors. The device has an extended part 60 and fastening mechanism 66 that allows securing the tracking device against the both container doors.

FIG. 7 is a container tracking system composed of a first unit 70 containing a tracking device and a second unit 72 containing antennas 74. Unit 70 and 72 are tied together using a flexible belt 76.

To attach the system, the user opens the two container doors slightly, inserts unit 70 behind the two container doors through the main opening. Unit 70 is placed towards the inside of the container, belt 76 is placed between the two container doors and unit 72 is placed to the exterior of the container. The user closed the container doors and slides unit 2 along the belt until the whole system grips to the container doors. Pin 78 is inserted through unit 2 to seal the system.

Numerous other modifications, variations, and adaptations may be made to the particular embodiment of the invention described above without departing from the scope of the invention, which is defined in the claims. Hence, while exemplary embodiments of the present invention have been set forth above, it is to be understood that the pioneer inventions disclosed herein may be constructed or used otherwise than as specifically described.

What is claimed is:

1. A unitary apparatus comprising:
a housing containing circuitry for determining status and location data associated with an attached shipping container and for communicating said data to a remote server;
an activation system, for electrically activating or deactivating the circuitry;
a latch for mechanically attaching and detaching said housing from the door edge of said shipping container;
said latch extends from the housing and is shaped to accommodate positioning of the housing adjacent to the container door, on the inside of the container,
said latch extends adjacent to the container door to the outside of the container and comprises a restraint mechanism and antennas for GPS and cellular receivers.

2. An apparatus as in claim 1 wherein said latch comprises a rotating part, said rotating part allows attaching said housing to both container doors.

3. An apparatus as in claim 1 wherein said activation system is a USB dongle.

4. An apparatus as in claim 1 comprising an alarm system.

5. A method for tracking a container using a unitary tamper proof apparatus comprising:
attaching a housing comprising a GPS receiver, a cellular receiver and circuitry for determining the status of said container adjacent to the container door to the inside of the container,
attaching a latch extending from said housing adjacent to the container door, to the exterior of the container,
fastening said latch to said container door.

6. The method of claim 5 comprising loading configuration information on a USB dongle and attaching said USB dongle to said housing.

7. The method of claim 6 comprising loading map information on said USB dongle.

8. The method of claim 6 whereby on receipt of an SMS message from a sender, said apparatus determines its GPS position information, correlates said information with information from said USB and sends an SMS message with location information.

9. The method of claim 8 whereby said SMS message comprises status information.

10. The method of claim 9 whereby said SMS message is sent to said sender.

11. The method of claim 10 whereby said SMS message is sent to one or more destination numbers obtained from said configuration information.

12. The method of claim 6 whereby on detection of an exception event defined as part of said configuration information, said apparatus sends an SMS message to one or more destination numbers obtained from said configuration information.

13. The method of claim 12 comprising on detection of an exception event defined as part of said configuration information, said apparatus starts an alarm.

14. The method of claim 13 whereby said alarm is higher than 100 decibels.

15. The method of claim 6 comprising on detecting an exception event defined as part of said configuration information, said apparatus calls one or more destination numbers obtained from said configuration information and reads a message.

16. The method of claim 12 whereby said exception event is selected from the set comprising:
opening a container door outside permitted areas,
navigation outside permitted zones,
temperature inside the container is outside permitted ranges.

17. The method of claim 7 whereby said apparatus authenticates the user by comparing a password entered by the user with a password obtainer from said configuration information.

18. A two part apparatus comprising:
a main housing containing circuitry for determining status and location data associated with an attached shipping container and for communicating said data to a remote server;
an activation system, for electrically activating or deactivating the circuitry;
a second housing containing antennas for GPS and mobile services,
a belt is fixed to said main housing and passes through a slot in said second housing,
said second housing slides along said belt and allows to secure said apparatus to container doors.

19. The apparatus of claim 18 whereby said belt is placed between the two container doors, said main housing is placed inside the container and said second housing is placed outside the container.

20. The apparatus of claim 19 whereby a pin is inserted through said second housing and through said belt to secure the system.
